(19) United States
(12) Patent Application Publication
(10) Pub. No.: US 2023/0362152 A1
(43) Pub. Date: Nov. 9, 2023

(54) MOBILE DYNAMIC APPLICATION PACKET KIT (APK)

(71) Applicant: Charter Communications Operating, LLC, St. Louis, MO (US)

(72) Inventors: Saurabh Sharma, Chesterfield, MO (US); Lavanya Yeleswarapu, St. Louis, MO (US); Vikas Pandey, O Fallon, MO (US)

(21) Appl. No.: 17/736,289

(22) Filed: May 4, 2022

(51) Int. Cl. H04L 9/40

(52) U.S. Cl. CPC H04L 63/083

(57) ABSTRACT

A method includes: receiving, by a device connected to a communications network, a neutral application packet kit; running, by the device, an instance of an application corresponding to the neutral application packet kit; requesting, by the application, endpoint data from an authentication cluster on the communications network; receiving, by the application, the endpoint data from the authentication cluster; and connecting, by the application, to an initial servicing cluster identified by the endpoint data.

### FIELD OF THE INVENTION

The present invention relates generally to the electrical, electronic and computer arts, and, more particularly, to maintenance of content networks.

### BACKGROUND OF THE INVENTION

Historically, the cable network was predominantly a vehicle for delivering entertainment. With the advent of the Internet and the rise in demand for broadband two-way access, the cable industry began to seek new ways of utilizing its existing plant. Pure coaxial (“coax”) cable networks were replaced with hybrid fiber/coax networks (HFCs) using optical fiber from the head end to the demarcation with the subscriber coax (usually at a fiber node). Currently, a content-based network, a non-limiting example of which is a cable television network, may afford access to a variety of services besides television, for example, broadband Internet access, telephone service, and the like. There are also fiber networks for fiber to the home (FTTH) deployments (also known as fiber to the premises or FTTP), where the CPE is a Service ONU (S-ONU; ONU=optical network unit).

One significant issue for a cable operator desiring to provide digital service is the configuration of its network. Designed for one-way delivery of broadcast signals, the existing cable network topology was optimized for downstream only (i.e., towards the subscriber) service. New equipment had to be added to the network to provide two-way communication. To reduce the cost of this equipment and to simplify the upgrade of the broadcast cable for two-way digital traffic, standards were developed for a variety of new cable-based services. The first of these standards, the Data Over Cable System Interface Standard (DOCSIS® standard), was released in 1998. DOCSIS® establishes standards for cable modems and supporting equipment. DOCSIS® (Data Over Cable Service Interface Specification) is a registered mark of Cable Television Laboratories, Inc. (CableLabs), 858 Coal Creek Circle, Louisville CO 80027, USA, and may be referred to at some points herein in capital letters, without the ® symbol, for convenience.

There are many types of IP networks besides cable networks. Other wired IP networks include, for example, digital subscriber line (DSL), fiber to the home, fiber to the curb, and so on. Wireless IP networks include Wi-Fi, wireless ISP (Internet Service Provider), WiMAX, satellite internet, and mobile broadband.

Field technicians, or simply technicians, typically use a tech-mobile application, which communicates with a tech-mobile server. The tech-mobile server can allocate a job to a given technician, and the tech-mobile applications enable the technician to view the details of the job, activate necessary equipment in the field, and close the job. The technician can also receive details of the next job from the tech-mobile server via the tech-mobile application.

The tech-mobile server may include a plurality of backend clusters to achieve availability and redundancy goals. In the case of a backend cluster failure, technicians from the failed backend cluster may have their service moved to a different backend cluster. The process of moving technicians' service requires that the technicians' devices download a new tech-mobiles application packet kit (APK) that is specific to the different backend cluster.

The process of moving technicians' service can be time consuming as a new APK is pushed via a master data management (MDM) process. The MDM process can take up to two hours. Further, the download of the new APK will be subject to the quality of the mobile signal received by the device of the technician.

### SUMMARY OF THE INVENTION

Principles of the invention provide techniques for a mobile dynamic application packet kit (APK).

According to some embodiments, a method includes: receiving, by a device connected to a communications network, a neutral application packet kit; running, by the device, an instance of an application corresponding to the neutral application packet kit; requesting, by the application, endpoint data from an authentication cluster on the communications network; receiving, by the application, the endpoint data from the authentication cluster; and connecting, by the application, to an initial servicing cluster identified by the endpoint data.

In another aspect, a method performed by an application running on a device, wherein the application corresponds to a neutral application packet kit, includes: communicating with a first instance of a service running on an initial servicing cluster; receiving a notification including endpoint data of a subsequent servicing cluster; logging off of the initial servicing cluster; and logging onto the subsequent servicing cluster using the endpoint data, wherein a second instance of the service is running on the subsequent servicing cluster.

In still another aspect, a method includes: determining a condition requiring routing of a client device running an application and communicating with a first in-stance of a service running on a first cluster; updating a profile associated with a technician logged into the first cluster via the client device, wherein the profile is stored on a plurality of mobile databases supporting a plurality of clusters, including the first cluster; and forcing a log off of the application from the first cluster.

According to some embodiments, an apparatus comprises: a communications network; a plurality of computer clusters, wherein each computer cluster of the plurality of clusters includes an instance of a profile service storing, locally, a replicated profile of a user, and wherein each computer cluster of the plurality of clusters includes a messaging service; at least one database connected to each of the clusters by the communications network, wherein data stored in the at least one database is shared by the plurality of computer clusters; and a user device running an application connected to a service of a first cluster of the plurality of clusters that uses the data stored in the at least one database, wherein the messaging service is configured to provide a notification to the application running on the user device enabling a login to a second cluster of the plurality of clusters providing the service.

As used herein, “facilitating” an action includes performing the action, making the action easier, helping to carry the action out, or causing the action to be performed. Thus, by way of example and not limitation, instructions executing on one processor might facilitate an action carried out by instructions executing on a remote processor, by sending appropriate data or commands to cause or aid the action to be performed. For the avoidance of doubt, where an actor facilitates an action by other than performing the action, the action is nevertheless performed by some entity or combination of entities.

One or more embodiments of the invention or elements thereof can be implemented in the form of an article of manufacture including a machine-readable medium that contains one or more programs which when executed implement one or more method steps set forth herein; that is to say, a computer program product including a tangible computer readable recordable storage medium (or multiple such media) with computer usable program code for performing the method steps indicated. Furthermore, one or more embodiments of the invention or elements thereof can be implemented in the form of an apparatus (e.g., see FIG. 7 and FIG. 15) including a memory and at least one processor that is coupled to the memory and operative to perform, or facilitate performance of, exemplary method steps. Yet further, in another aspect, one or more embodiments of the invention or elements thereof can be implemented in the form of means for carrying out one or more of the method steps described herein; the means can include (i) specialized hardware module(s), (ii) software module(s) stored in a tangible computer-readable recordable storage medium (or multiple such media) and implemented on a hardware processor, or (iii) a combination of (i) and (ii); any of (i)-(iii) implement the specific techniques set forth herein.

Aspects of the present invention can provide substantial beneficial technical effects. For example, one or more embodiments of the invention achieve one or more of:
routing a service between clusters;
routing a service between clusters without an application package kit download to facilitate the routing;
a neutral application package kit supporting communications with any cluster of a plurality of clusters; and
an active/active architecture facilitating dynamic routing of a device between clusters of servers by sending updated endpoint data of a subsequent cluster to the device, minimizing or eliminating downtime in a case when a current cluster becomes unavailable.

These and other features and advantages of the present invention will become apparent from the following detailed description of illustrative embodiments thereof, which is to be read in connection with the accompanying drawings.

### BRIEF DESCRIPTION OF THE DRAWINGS

The following drawings are presented by way of example only and without limitation, wherein like reference numerals (when used) indicate corresponding elements throughout the several views, and wherein:

FIG. 1 is a block diagram of an exemplary embodiment of a system, within which one or more aspects of the invention can be implemented;

FIG. 2 is a functional block diagram illustrating an exemplary hybrid fiber-coaxial (HFC) divisional network configuration, useful within the system of FIG. 1;

FIG. 3 is a functional block diagram illustrating one exemplary HFC cable network head-end configuration, useful within the system of FIG. 1;

FIG. 4 is a functional block diagram illustrating one exemplary local service node configuration useful within the system of FIG. 1;

FIG. 5 is a functional block diagram of a premises network, including an exemplary centralized customer premises equipment (CPE) unit, interfacing with a head end such as that of FIG. 3;

FIG. 6 is a functional block diagram of an exemplary centralized CPE unit, useful within the system of FIG. 1;

FIG. 7 is a block diagram of a computer system useful in connection with one or more aspects of the invention;

FIG. 8 is a functional block diagram illustrating an exemplary FTTH system, which is one exemplary system within which one or more embodiments could be employed;

FIG. 9 is a functional block diagram of an exemplary centralized S-ONU CPE unit interfacing with the system of FIG. 8;

FIG. 10 is a flow diagram of a method for dynamic routing of a service (of client devices) between clusters of servers in accordance with an example embodiment;

FIG. 11 is a diagram of a system including a plurality of clusters in accordance with an example embodiment;

FIG. 12 is a diagram of a system including a plurality of clusters in accordance with an example embodiment;

FIG. 13 is a diagram of a table structure of a data system supporting the dynamic routing of a service (serving client devices) between clusters of servers in accordance with an example embodiment;

FIG. 14 is a diagram of a system including a plurality of clusters in accordance with an example embodiment;

FIG. 15 is a diagram of a system including a plurality of clusters in accordance with an example embodiment;

FIG. 16 is a diagram of a system including a plurality of clusters in accordance with an example embodiment; and

FIG. 17 is a swim lane diagram of a method for dynamically routing of a service to a mobile application in accordance with an example embodiment.

### DETAILED DESCRIPTION OF PREFERRED EMBODIMENTS

Embodiments of the present invention are related to apparatus, systems, and methods for dynamic routing of a service (of client devices) between clusters of servers (hereinafter clusters), without the download of a new application package kit (APK) to the client devices. A cluster typically includes a group of two or more computers, or nodes, which run software in parallel (and typically coordinated), where the nodes are available to work on a common task, which may be distributed among the nodes of the cluster.

According to some aspects, an APK is a package file format (typically for ANDROID Applications) (registered mark of GOOGLE LLC MOUNTAIN VIEW CALIFORNIA) containing the elements of an application, including resources, certificates, etc. According to some aspects, services are elements of the application that perform certain operations (e.g., long-running operations such as computations, input/output, network, etc.). According to some embodiments, services run in a background of the application, performing work for remote processes or long-running operations.

According to some aspects, a dynamic routing may be performed using a profile maintained for each technician having a client device in a micro-service or service called a profile. It should be understood that a micro-service and a service can be considered technically, or functionally, the same, but that the term “micro-service” may be used in cases of relatively narrow scope and focus. According to some embodiments, the service can allocate the technicians to groups, wherein a group of technicians can be moved between different clusters. Embodiments of the present invention support the movement of individual technicians and the movement of group(s) of technicians.

Embodiments of the present invention enable geo-redundancy, disaster recovery support, load balancing, etc. Embodiments of the present invention enable lateral and rollback movement of technicians. Embodiments of the present invention support data redundancy and availability, with a service available on different clusters using the same data.

According to at least one embodiment, a cluster is a Kubernetes cluster, which is well-known in the art. It should be understood that other cluster types could be implemented without departing from the scope of the present disclosure.

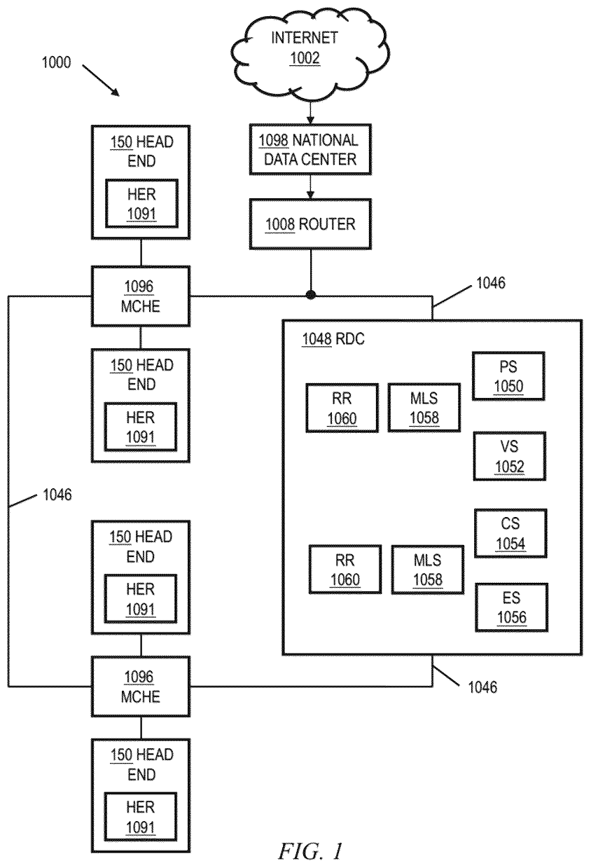

Purely by way of example and not limitation, some embodiments will be shown in the context of a cable multi-service operator (MSO) providing data services as well as entertainment services. FIG. 1 shows an exemplary system 1000, according to an aspect of the invention. System 1000 includes a regional data center (RDC) 1048 coupled to several Market Center Head Ends (MCHEs) 1096; each MCHE 1096 is in turn coupled to one or more divisions, represented by division head ends 150. In a non-limiting example, the MCHEs are coupled to the RDC 1048 via a network of switches and routers. One suitable example of network 1046 is a dense wavelength division multiplex (DWDM) network. The MCHEs can be employed, for example, for large metropolitan area(s). In addition, the MCHE is connected to localized HEs 150 via high-speed routers 1091 (“HER”=head end router) and a suitable network, which could, for example, also utilize DWDM technology. Elements 1048, 1096 on network 1046 may be operated, for example, by or on behalf of a cable MSO, and may be interconnected with a global system of interconnected computer networks that use the standardized Internet Protocol Suite (TCP/IP) (transfer control protocol/Internet protocol), commonly called the Internet 1002; for example, via router 1008. In one or more non-limiting exemplary embodiments, router 1008 is a point-of-presence (“POP”) router; for example, of the kind available from Juniper Networks, Inc., Sunnyvale, California, USA.

Head end routers 1091 are omitted from figures below to avoid clutter, and not all switches, routers, etc. associated with network 1046 are shown, also to avoid clutter.

RDC 1048 may include one or more provisioning servers (PS) 1050, one or more Video Servers (VS) 1052, one or more content servers (CS) 1054, and one or more e-mail servers (ES) 1056. The same may be interconnected to one or more RDC routers (RR) 1060 by one or more multi-layer switches (MLS) 1058. RDC routers 1060 interconnect with network 1046.

A national data center (NDC) 1098 is provided in some instances; for example, between router 1008 and Internet 1002. In one or more embodiments, such an NDC may consolidate at least some functionality from head ends (local and/or market center) and/or regional data centers. For example, such an NDC might include one or more VOD servers; switched digital video (SDV) functionality; gateways to obtain content (e.g., program content) from various sources including cable feeds and/or satellite; and so on.

In some cases, there may be more than one national data center 1098 (e.g., two) to provide redundancy. There can be multiple regional data centers 1048. In some cases, MCHEs could be omitted and the local head ends 150 coupled directly to the RDC 1048.

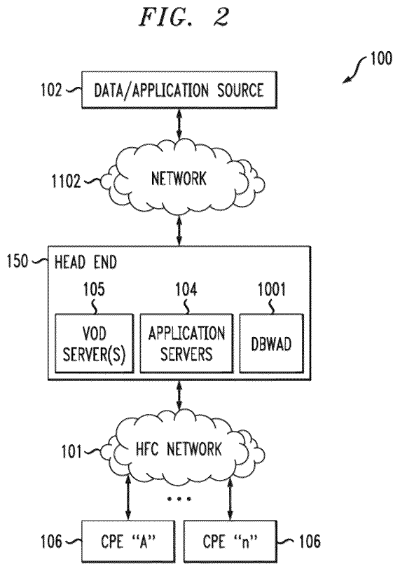

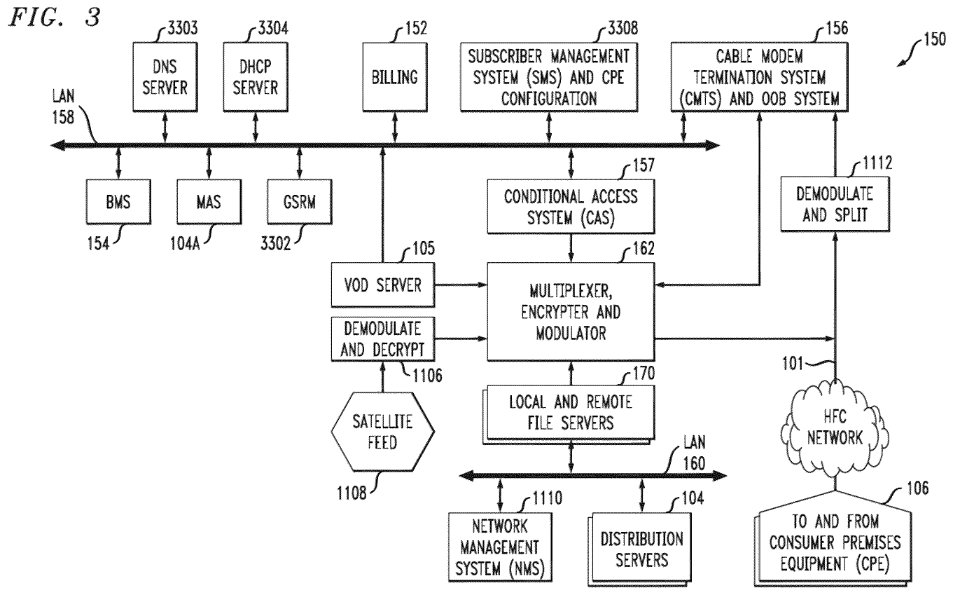

FIG. 2 is a functional block diagram illustrating an exemplary content-based (e.g., hybrid fiber-coaxial (HFC)) divisional network configuration, useful within the system of FIG. 1. See, for example, US Patent Publication 2006/0130107 of Gonder et al., entitled “Method and apparatus for high bandwidth data transmission in content-based networks,” the complete disclosure of which is expressly incorporated by reference herein in its entirety for all purposes. The various components of the network 100 include (i) one or more data and application origination points 102; (ii) one or more application distribution servers 104; (iii) one or more video-on-demand (VOD) servers 105, and (v) consumer premises equipment or customer premises equipment (CPE). The distribution server(s) 104, VOD servers 105 and CPE(s) 106 are connected via a bearer (e.g., HFC) network 101. Servers 104, 105 can be located in head end 150. A simple architecture is shown in FIG. 2 for illustrative brevity, although it will be recognized that comparable architectures with multiple origination points, distribution servers, VOD servers, and/or CPE devices (as well as different network topologies) may be utilized consistent with embodiments of the invention. For example, the head-end architecture of FIG. 3 (described in greater detail below) may be used.

It should be noted that the exemplary CPE 106 is an integrated solution including a cable modem (e.g., DOCSIS) and one or more wireless routers. Other embodiments could employ a two-box solution; i.e., separate cable modem and routers suitably interconnected, which nevertheless, when interconnected, can provide equivalent functionality. Furthermore, FTTH networks can employ Service ONUS (S-ONUS; ONU=optical network unit) as CPE, as discussed elsewhere herein.

The data/application origination point 102 comprises any medium that allows data and/or applications (such as a VOD-based or “Watch TV” application) to be transferred to a distribution server 104, for example, over network 1102. This can include for example a third-party data source, application vendor website, compact disk read-only memory (CD-ROM), external network interface, mass storage device (e.g., Redundant Arrays of Inexpensive Disks (RAID) system), etc. Such transference may be automatic, initiated upon the occurrence of one or more specified events (such as the receipt of a request packet or acknowledgement (ACK)), performed manually, or accomplished in any number of other modes readily recognized by those of ordinary skill, given the teachings herein. For example, in one or more embodiments, network 1102 may correspond to network 1046 of FIG. 1, and the data and application origination point may be, for example, within NDC 1098, RDC 1048, or on the Internet 1002. Head end 150, HFC network 101, and CPEs 106 thus represent the divisions which were represented by division head ends 150 in FIG. 1.

The application distribution server 104 comprises a computer system where such applications can enter the network system. Distribution servers per se are well known in the networking arts, and accordingly not described further herein.

The VOD server 105 comprises a computer system where on-demand content can be received from one or more of the aforementioned data sources 102 and enter the network system. These servers may generate the content locally, or alternatively act as a gateway or intermediary from a distant source.

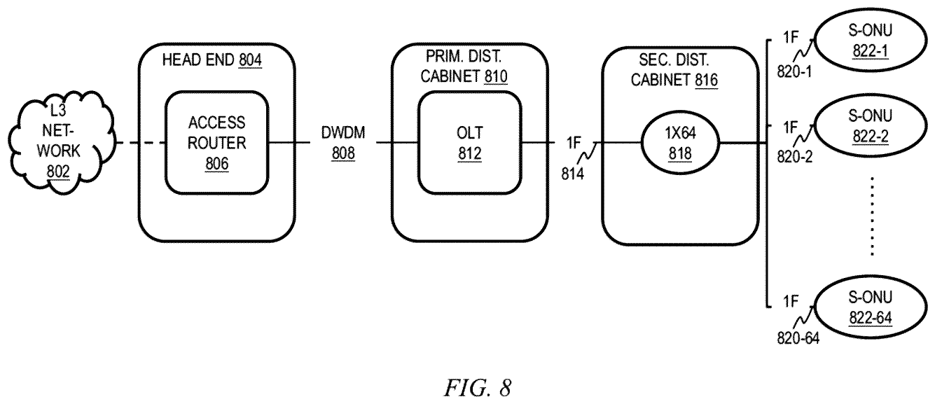

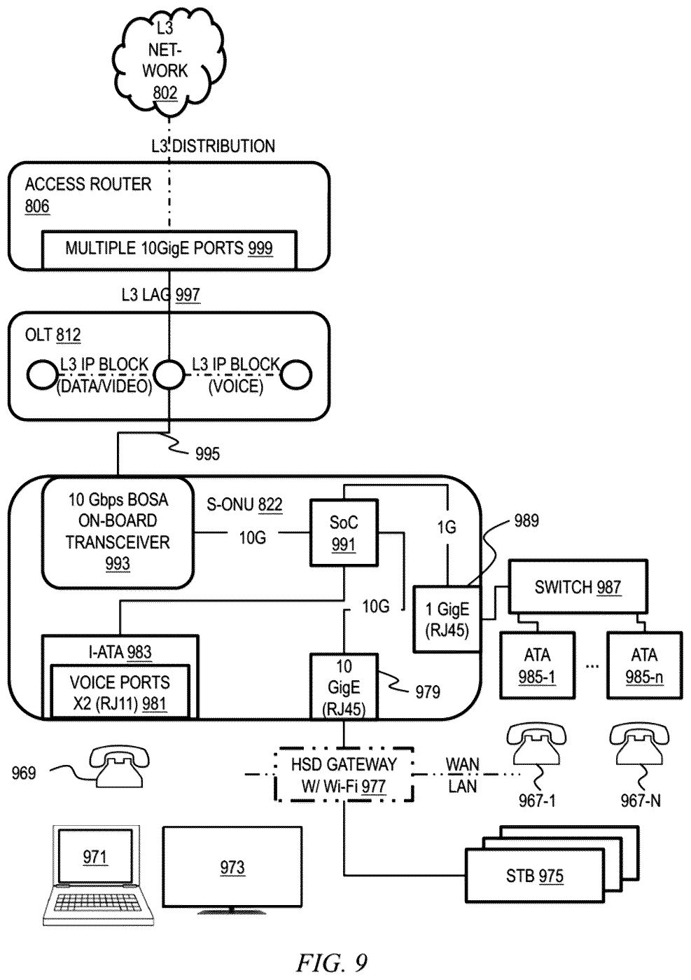

The CPE 106 includes any equipment in the “customers' premises” (or other appropriate locations) that can be accessed by the relevant upstream network components. Non-limiting examples of relevant upstream network components, in the context of the HFC network, include a distribution server 104 or a cable modem termination system 156 (discussed below with regard to FIG. 3). The skilled artisan will be familiar with other relevant upstream network components for other kinds of networks (e.g., FTTH) as discussed herein. Non-limiting examples of CPE are set-top boxes, high-speed cable modems, and Advanced Wireless Gateways (AWGs) for providing high bandwidth Internet access in premises such as homes and businesses. Reference is also made to the discussion of an exemplary FTTH network in connection with FIGS. 8 and 9.

Also included (for example, in head end 150) is a dynamic bandwidth allocation device (DBWAD) 1001 such as a global session resource manager, which is itself a non-limiting example of a session resource manager.

FIG. 3 is a functional block diagram illustrating one exemplary HFC cable network head-end configuration, useful within the system of FIG. 1. As shown in FIG. 3, the head-end architecture 150 comprises typical head-end components and services including billing module 152, subscriber management system (SMS) and CPE configuration management module 3308, cable-modem termination system (CMTS) and out-of-band (OOB) system 156, as well as LAN(s) 158, 160 placing the various components in data communication with one another. In one or more embodiments, there are multiple CMTSs. Each may be coupled to an HER 1091, for example. See, e.g., FIGS. 1 and 2 of co-assigned U.S. Pat. No. 7,792,963 of inventors Gould and Danforth, entitled METHOD TO BLOCK UNAUTHORIZED NETWORK TRAFFIC IN A CABLE DATA NETWORK, the complete disclosure of which is expressly incorporated herein by reference in its entirety for all purposes.

It will be appreciated that while a bar or bus LAN topology is illustrated, any number of other arrangements (e.g., ring, star, etc.) may be used consistent with the invention. It will also be appreciated that the head-end configuration depicted in FIG. 3 is high-level, conceptual architecture and that each multi-service operator (MSO) may have multiple head-ends deployed using custom architectures.

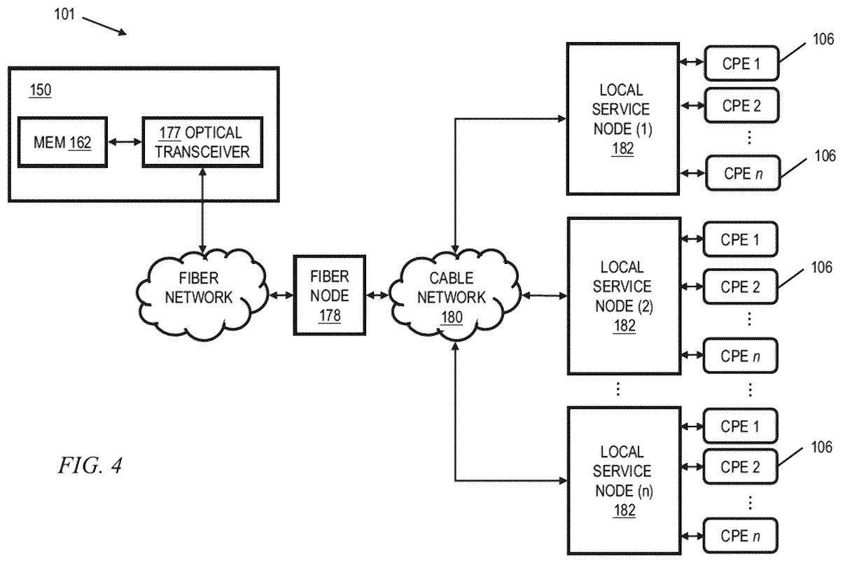

The architecture 150 of FIG. 3 further includes a multiplexer/encrypter/modulator (MEM) 162 coupled to the HFC network 101 adapted to “condition” content for transmission over the network. The distribution servers 104 are coupled to the LAN 160, which provides access to the MEM 162 and network 101 via one or more file servers 170. The VOD servers 105 are coupled to the LAN 158, although other architectures may be employed (such as for example where the VOD servers are associated with a core switching device such as an 802.3z Gigabit Ethernet device; or the VOD servers could be coupled to LAN 160). Since information is typically carried across multiple channels, the head-end should be adapted to acquire the information for the carried channels from various sources. Typically, the channels being delivered from the head-end 150 to the CPE 106 (“downstream”) are multiplexed together in the head-end and sent to neighborhood hubs (refer to description of FIG. 4) via a variety of interposed network components.

Content (e.g., audio, video, etc.) is provided in each downstream (in-band) channel associated with the relevant service group. (Note that in the context of data communications, internet data is passed both downstream and upstream.) To communicate with the head-end or intermediary node (e.g., hub server), the CPE 106 may use the out-of-band (OOB) or DOCSIS® (Data Over Cable Service Interface Specification) channels (registered mark of Cable Television Laboratories, Inc. (CableLabs), 858 Coal Creek Circle, Louisville CO 80027, USA) and associated protocols (e.g., DOCSIS 1.x, 2.0. or 3.0). The OpenCable™ Application Platform (OCAP) 1.0, 2.0, 3.0 (and subsequent) specification (Cable Television laboratories Inc.) provides for exemplary networking protocols both downstream and upstream, although the invention is in no way limited to these approaches. All versions of the DOCSIS and OCAP specifications are expressly incorporated herein by reference in their entireties for all purposes.

Furthermore in this regard, DOCSIS is an international telecommunications standard that permits the addition of high-speed data transfer to an existing cable TV (CATV) system. It is employed by many cable television operators to provide Internet access (cable Internet) over their existing hybrid fiber-coaxial (HFC) infrastructure. HFC systems using DOCSIS to transmit data are one non-limiting exemplary application context for one or more embodiments. However, one or more embodiments are applicable to a variety of different kinds of networks.

It is also worth noting that the use of DOCSIS Provisioning of EPON (Ethernet over Passive Optical Network) or “DPoE” (Specifications available from CableLabs, Louisville, CO, USA) enables the transmission of high-speed data over PONs using DOCSIS back-office systems and processes.

It will also be recognized that multiple servers (broadcast, VOD, or otherwise) can be used, and disposed at two or more different locations if desired, such as being part of different server “farms”. These multiple servers can be used to feed one service group, or alternatively different service groups. In a simple architecture, a single server is used to feed one or more service groups. In another variant, multiple servers located at the same location are used to feed one or more service groups. In yet another variant, multiple servers disposed at different location are used to feed one or more service groups.

In some instances, material may also be obtained from a satellite feed 1108; such material is demodulated and decrypted in block 1106 and fed to block 162. Conditional access system 157 may be provided for access control purposes. Network management system 1110 may provide appropriate management functions. Note also that signals from MEM 162 and upstream signals from network 101 that have been demodulated and split in block 1112 are fed to CMTS and OOB system 156.

Also included in FIG. 3 are a global session resource manager (GSRM) 3302, a Mystro Application Server 104A, and a business management system 154, all of which are coupled to LAN 158. GSRM 3302 is one specific form of a DBWAD 1001 and is a non-limiting example of a session resource manager.

An ISP DNS server could be located in the head-end as shown at 3303, but it can also be located in a variety of other places. One or more Dynamic Host Configuration Protocol (DHCP) server(s) 3304 can also be located where shown or in different locations.

It should be noted that the exemplary architecture in FIG. 3 shows a traditional location for the CMTS 156 in a head end. As will be appreciated by the skilled artisan, CMTS functionality can be moved down closer to the customers or up to a national or regional data center or can be dispersed into one or more locations.

As shown in FIG. 4, the network 101 of FIGS. 2 and 3 comprises a fiber/coax arrangement wherein the output of the MEM 162 of FIG. 3 is transferred to the optical domain (such as via an optical transceiver 177 at the head-end 150 or further downstream). The optical domain signals are then distributed over a fiber network 179 to a fiber node 178, which further distributes the signals over a distribution network 180 (typically coax) to a plurality of local servicing nodes 182. This provides an effective 1-to-N expansion of the network at the local service end. Each node 182 services a number of CPEs 106. Further reference may be had to US Patent Publication 2007/0217436 of Markley et al., entitled “Methods and apparatus for centralized content and data delivery,” the complete disclosure of which is expressly incorporated herein by reference in its entirety for all purposes. In one or more embodiments, the CPE 106 includes a cable modem, such as a DOCSIS-compliant cable modem (DCCM). Please note that the number n of CPE 106 per node 182 may be different than the number n of nodes 182, and that different nodes may service different numbers n of CPE.

Certain additional aspects of video or other content delivery will now be discussed. It should be understood that embodiments of the invention have broad applicability to a variety of different types of networks. Some embodiments relate to TCP/IP network connectivity for delivery of messages and/or content. Again, delivery of data over a video (or other) content network is but one non-limiting example of a context where one or more embodiments could be implemented. US Patent Publication 2003-0056217 of Paul D. Brooks, entitled “Technique for Effectively Providing Program Material in a Cable Television System,” the complete disclosure of which is expressly incorporated herein by reference for all purposes, describes one exemplary broadcast switched digital architecture, although it will be recognized by those of ordinary skill that other approaches and architectures may be substituted. In a cable television system in accordance with the Brooks invention, program materials are made available to subscribers in a neighborhood on an as-needed basis. Specifically, when a subscriber at a set-top terminal selects a program channel to watch, the selection request is transmitted to a head end of the system. In response to such a request, a controller in the head end determines whether the material of the selected program channel has been made available to the neighborhood. If it has been made available, the controller identifies to the set-top terminal the carrier which is carrying the requested program material, and to which the set-top terminal tunes to obtain the requested program material. Otherwise, the controller assigns an unused carrier to carry the requested program material, and informs the set-top terminal of the identity of the newly assigned carrier. The controller also retires those carriers assigned for the program channels which are no longer watched by the subscribers in the neighborhood. Note that reference is made herein, for brevity, to features of the “Brooks invention”—it should be understood that no inference should be drawn that such features are necessarily present in all claimed embodiments of Brooks. The Brooks invention is directed to a technique for utilizing limited network bandwidth to distribute program materials to subscribers in a community access television (CATV) system. In accordance with the Brooks invention, the CATV system makes available to subscribers selected program channels, as opposed to all of the program channels furnished by the system as in prior art. In the Brooks CATV system, the program channels are provided on an as needed basis, and are selected to serve the subscribers in the same neighborhood requesting those channels.

US Patent Publication 2010-0313236 of Albert Straub, entitled “TECHNIQUES FOR UPGRADING SOFTWARE IN A VIDEO CONTENT NETWORK,” the complete disclosure of which is expressly incorporated herein by reference for all purposes, provides additional details on the aforementioned dynamic bandwidth allocation device 1001.

US Patent Publication 2009-0248794 of William L. Helms, entitled “SYSTEM AND METHOD FOR CONTENT SHARING,” the complete disclosure of which is expressly incorporated herein by reference for all purposes, provides additional details on CPE in the form of a converged premises gateway device. Related aspects are also disclosed in US Patent Publication 2007-0217436 of Markley et al, entitled “METHODS AND APPARATUS FOR CENTRALIZED CONTENT AND DATA DELIVERY,” the complete disclosure of which is expressly incorporated herein by reference for all purposes.

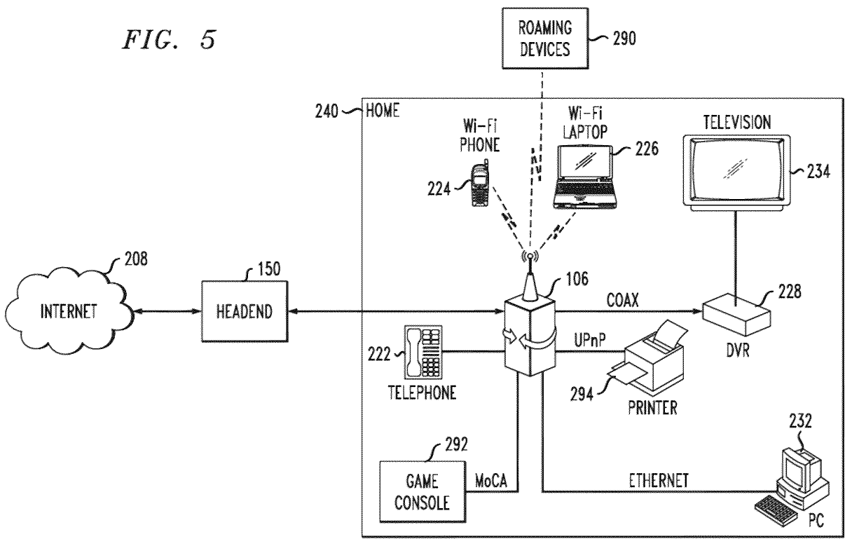

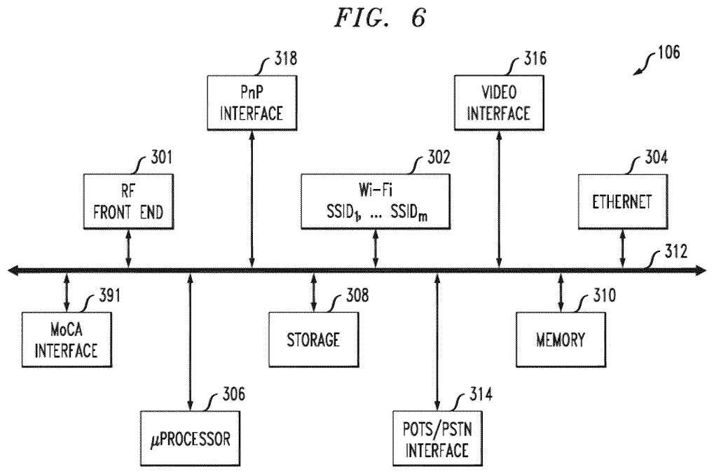

Reference should now be had to FIG. 5, which presents a block diagram of a premises network interfacing with a head end of an MSO or the like, providing Internet access. An exemplary advanced wireless gateway comprising CPE 106 is depicted as well. It is to be emphasized that the specific form of CPE 106 shown in FIGS. 5 and 6 is exemplary and non-limiting, and shows a number of optional features. Many other types of CPE can be employed in one or more embodiments; for example, a cable modem, DSL modem, and the like. The CPE can also be a Service Optical Network Unit (S-ONU) for FTTH deployment—see FIGS. 8 and 9 and accompanying text.

CPE 106 includes an advanced wireless gateway which connects to a head end 150 or other hub of a network, such as a video content network of an MSO or the like. The head end is coupled also to an internet (e.g., the Internet) 208 which is located external to the head end 150, such as via an Internet (IP) backbone or gateway (not shown).

The head end is in the illustrated embodiment coupled to multiple households or other premises, including the exemplary illustrated household 240. In particular, the head end (for example, a cable modem termination system 156 thereof) is coupled via the aforementioned HFC network and local coaxial cable or fiber drop to the premises, including the consumer premises equipment (CPE) 106. The exemplary CPE 106 is in signal communication with any number of different devices including, e.g., a wired telephony unit 222, a Wi-Fi or other wireless-enabled phone 224, a Wi-Fi or other wireless-enabled laptop 226, a session initiation protocol (SIP) phone, an H.323 terminal or gateway, etc. Additionally, the CPE 106 is also coupled to a digital video recorder (DVR) 228 (e.g., over coax), in turn coupled to television 234 via a wired or wireless interface (e.g., cabling, PAN or 802.15 UWB micro-net, etc.). CPE 106 is also in communication with a network (here, an Ethernet network compliant with IEEE Std. 802.3, although any number of other network protocols and topologies could be used) on which is a personal computer (PC) 232.

Other non-limiting exemplary devices that CPE 106 may communicate with include a printer 294; for example, over a universal plug and play (UPnP) interface, and/or a game console 292; for example, over a multimedia over coax alliance (MoCA) interface.

In some instances, CPE 106 is also in signal communication with one or more roaming devices, generally represented by block 290.

A “home LAN” (HLAN) is created in the exemplary embodiment, which may include for example the network formed over the installed coaxial cabling in the premises, the Wi-Fi network, and so forth.

During operation, the CPE 106 exchanges signals with the head end over the interposed coax (and/or other, e.g., fiber) bearer medium. The signals include e.g., Internet traffic (IPv4 or IPv6), digital programming and other digital signaling or content such as digital (packet-based; e.g., VoIP) telephone service. The CPE 106 then exchanges this digital information after demodulation and any decryption (and any demultiplexing) to the particular system(s) to which it is directed or addressed. For example, in one embodiment, a MAC address or IP address can be used as the basis of directing traffic within the client-side environment 240.

Any number of different data flows may occur within the network depicted in FIG. 5. For example, the CPE 106 may exchange digital telephone signals from the head end which are further exchanged with the telephone unit 222, the Wi-Fi phone 224, or one or more roaming devices 290. The digital telephone signals may be IP-based such as Voice-over-IP (VoIP), or may utilize another protocol or transport mechanism. The well-known session initiation protocol (SIP) may be used, for example, in the context of a “SIP phone” for making multi-media calls. The network may also interface with a cellular or other wireless system, such as for example a 3G IMS (IP multimedia subsystem) system, in order to provide multimedia calls between a user or consumer in the household domain 240 (e.g., using a SIP phone or H.323 terminal) and a mobile 3G telephone or personal media device (PMD) user via that user's radio access network (RAN).

The CPE 106 may also exchange Internet traffic (e.g., TCP/IP and other packets) with the head end 150 which is further exchanged with the Wi-Fi laptop 226, the PC 232, one or more roaming devices 290, or other device. CPE 106 may also receive digital programming that is forwarded to the DVR 228 or to the television 234. Programming requests and other control information may be received by the CPE 106 and forwarded to the head end as well for appropriate handling.

FIG. 6 is a block diagram of one exemplary embodiment of the CPE 106 of FIG. 5. The exemplary CPE 106 includes an RF front end 301, Wi-Fi interface 302, video interface 316, “Plug n′ Play” (PnP) interface 318 (for example, a UPnP interface) and Ethernet interface 304, each directly or indirectly coupled to a bus 312. In some cases, Wi-Fi interface 302 comprises a single wireless access point (WAP) running multiple (“m”) service set identifiers (SSIDs). In some cases, multiple SSIDs, which could represent different applications, are served from a common WAP. For example, SSID 1 is for the home user, while SSID 2 may be for a managed security service, SSID 3 may be a managed home networking service, SSID 4 may be a hot spot, and so on. Each of these is on a separate IP subnetwork for security, accounting, and policy reasons. The microprocessor 306, storage unit 308, plain old telephone service (POTS)/public switched telephone network (PSTN) interface 314, and memory unit 310 are also coupled to the exemplary bus 312, as is a suitable MoCA interface 391. The memory unit 310 typically comprises a random-access memory (RAM) and storage unit 308 typically comprises a hard disk drive, an optical drive (e.g., CD-ROM or DVD), NAND flash memory, RAID (redundant array of inexpensive disks) configuration, or some combination thereof.

The illustrated CPE 106 can assume literally any discrete form factor, including those adapted for desktop, floor-standing, or wall-mounted use, or alternatively may be integrated in whole or part (e.g., on a common functional basis) with other devices if desired.

Again, it is to be emphasized that every embodiment need not necessarily have all the elements shown in FIG. 6—as noted, the specific form of CPE 106 shown in FIGS. 5 and 6 is exemplary and non-limiting, and shows a number of optional features. Yet again, many other types of CPE can be employed in one or more embodiments; for example, a cable modem, DSL modem, and the like.

It will be recognized that while a linear or centralized bus architecture is shown as the basis of the exemplary embodiment of FIG. 6, other bus architectures and topologies may be used. For example, a distributed or multi-stage bus architecture may be employed. Similarly, a “fabric” or other mechanism (e.g., crossbar switch, RAPIDIO interface, non-blocking matrix, TDMA or multiplexed system, etc.) may be used as the basis of at least some of the internal bus communications within the device. Furthermore, many if not all of the foregoing functions may be integrated into one or more integrated circuit (IC) devices in the form of an ASIC or “system-on-a-chip” (SoC). Myriad other architectures well known to those in the data processing and computer arts may accordingly be employed.

Yet again, it will also be recognized that the CPE configuration shown is essentially for illustrative purposes, and various other configurations of the CPE 106 are consistent with other embodiments of the invention. For example, the CPE 106 in FIG. 6 may not include all of the elements shown, and/or may include additional elements and interfaces such as for example an interface for the HomePlug A/V standard which transmits digital data over power lines, a PAN (e.g., 802.15), Bluetooth, or other short-range wireless interface for localized data communication, etc.

A suitable number of standard 10/100/1000 Base T Ethernet ports for the purpose of a Home LAN connection are provided in the exemplary device of FIG. 6; however, it will be appreciated that other rates (e.g., Gigabit Ethernet or 10-Gig-E) and local networking protocols (e.g., MoCA, USB, etc.) may be used. These interfaces may be serviced via a WLAN interface, wired RJ-45 ports, or otherwise. The CPE 106 can also include a plurality of RJ-11 ports for telephony interface, as well as a plurality of USB (e.g., USB 2.0) ports, and IEEE-1394 (Firewire) ports. S-video and other signal interfaces may also be provided if desired.

During operation of the CPE 106, software located in the storage unit 308 is run on the microprocessor 306 using the memory unit 310 (e.g., a program memory within or external to the microprocessor). The software controls the operation of the other components of the system, and provides various other functions within the CPE. Other system software/firmware may also be externally reprogrammed, such as using a download and reprogramming of the contents of the flash memory, replacement of files on the storage device or within other non-volatile storage, etc. This allows for remote reprogramming or reconfiguration of the CPE 106 by the MSO or other network agent.

It should be noted that some embodiments provide a cloud-based user interface, wherein CPE 106 accesses a user interface on a server in the cloud, such as in NDC 1098.

The RF front end 301 of the exemplary embodiment comprises a cable modem of the type known in the art. In some cases, the CPE just includes the cable modem and omits the optional features. Content or data normally streamed over the cable modem can be received and distributed by the CPE 106, such as for example packetized video (e.g., IPTV). The digital data exchanged using RF front end 301 includes IP or other packetized protocol traffic that provides access to internet service. As is well known in cable modem technology, such data may be streamed over one or more dedicated QAMs resident on the HFC bearer medium, or even multiplexed or otherwise combined with QAMs allocated for content delivery, etc. The packetized (e.g., IP) traffic received by the CPE 106 may then be exchanged with other digital systems in the local environment 240 (or outside this environment by way of a gateway or portal) via, e.g., the Wi-Fi interface 302, Ethernet interface 304 or plug-and-play (PnP) interface 318.

Additionally, the RF front end 301 modulates, encrypts/multiplexes as required, and transmits digital information for receipt by upstream entities such as the CMTS or a network server. Digital data transmitted via the RF front end 301 may include, for example, MPEG-2 encoded programming data that is forwarded to a television monitor via the video interface 316. Programming data may also be stored on the CPE storage unit 308 for later distribution by way of the video interface 316, or using the Wi-Fi interface 302, Ethernet interface 304, Firewire (IEEE Std. 1394), USB/USB2, or any number of other such options.

Other devices such as portable music players (e.g., MP3 audio players) may be coupled to the CPE 106 via any number of different interfaces, and music and other media files downloaded for portable use and viewing.

In some instances, the CPE 106 includes a DOCSIS cable modem for delivery of traditional broadband Internet services. This connection can be shared by all Internet devices in the premises 240; e.g., Internet protocol television (IPTV) devices, PCs, laptops, etc., as well as by roaming devices 290. In addition, the CPE 106 can be remotely managed (such as from the head end 150, or another remote network agent) to support appropriate IP services. Some embodiments could utilize a cloud-based user interface, wherein CPE 106 accesses a user interface on a server in the cloud, such as in NDC 1098.

In some instances, the CPE 106 also creates a home Local Area Network (LAN) utilizing the existing coaxial cable in the home. For example, an Ethernet-over-coax based technology allows services to be delivered to other devices in the home utilizing a frequency outside (e.g., above) the traditional cable service delivery frequencies. For example, frequencies on the order of 1150 MHz could be used to deliver data and applications to other devices in the home such as PCs, PMDs, media extenders and set-top boxes. The coaxial network is merely the bearer; devices on the network utilize Ethernet or other comparable networking protocols over this bearer.

The exemplary CPE 106 shown in FIGS. 5 and 6 acts as a Wi-Fi access point (AP), thereby allowing Wi-Fi enabled devices to connect to the home network and access Internet, media, and other resources on the network. This functionality can be omitted in one or more embodiments.

In one embodiment, Wi-Fi interface 302 comprises a single wireless access point (WAP) running multiple (“m”) service set identifiers (SSIDs). One or more SSIDs can be set aside for the home network while one or more SSIDs can be set aside for roaming devices 290.

A premises gateway software management package (application) is also provided to control, configure, monitor and provision the CPE 106 from the cable head-end 150 or other remote network node via the cable modem (DOCSIS) interface. This control allows a remote user to configure and monitor the CPE 106 and home network. Yet again, it should be noted that some embodiments could employ a cloud-based user interface, wherein CPE 106 accesses a user interface on a server in the cloud, such as in NDC 1098. The MoCA interface 391 can be configured, for example, in accordance with the MoCA 1.0, 1.1, or 2.0 specifications.

As discussed above, the optional Wi-Fi wireless interface 302 is, in some instances, also configured to provide a plurality of unique service set identifiers (SSIDs) simultaneously. These SSIDs are configurable (locally or remotely), such as via a web page.

As noted, there are also fiber networks for fiber to the home (FTTH) deployments (also known as fiber to the premises or FTTP), where the CPE is a Service ONU (S-ONU; ONU=optical network unit). Referring now to FIG. 8, L3 network 1802 generally represents the elements in FIG. 1 upstream of the head ends 150, while head end 1804, including access router 1806, is an alternative form of head end that can be used in lieu of or in addition to head ends 150 in one or more embodiments. Head end 1804 is suitable for FTTH implementations. Access router 1806 of head end 1804 is coupled to optical line terminal (OLT) 1812 in primary distribution cabinet 1810 via dense wavelength division multiplexing (DWDM) network 1808. Single fiber coupling 1814 is then provided to a 1:64 splitter 1818 in secondary distribution cabinet 1816 which provides a 64:1 expansion to sixty-four S-ONUs 1822-1 through 1822-64 (in multiple premises) via sixty-four single fibers 1820-1 through 1820-64, it being understood that a different ratio splitter could be used in other embodiments and/or that not all of the 64 (or other number of) outlet ports are necessarily connected to an S-ONU.

Giving attention now to FIG. 9, wherein elements similar to those in FIG. 8 have been given the same reference number, access router 1806 is provided with multiple ten-Gigabit Ethernet ports 1999 and is coupled to OLT 1812 via L3 (layer 3) link aggregation group (LAG) 1997. OLT 1812 can include an L3 IP block for data and video, and another L3 IP block for voice, for example. In a non-limiting example, S-ONU 1822 includes a 10 Gbps bi-directional optical subassembly (BOSA) on-board transceiver 1993 with a 10G connection to system-on-chip (SoC) 1991. SoC 1991 is coupled to a 10 Gigabit Ethernet RJ45 port 1979, to which a high-speed data gateway 1977 with Wi-Fi capability is connected via category 5E cable. Gateway 1977 is coupled to one or more set-top boxes 1975 via category 5e, and effectively serves as a wide area network (WAN) to local area network (LAN) gateway. Wireless and/or wired connections can be provided to devices such as laptops 1971, televisions 1973, and the like, in a known manner. Appropriate telephonic capability can be provided. In a non-limiting example, residential customers are provided with an internal integrated voice gateway (I-ATA or internal analog telephone adapter) 1983 coupled to SoC 1991, with two RJ11 voice ports 1981 to which up to two analog telephones 1969 can be connected. Furthermore, in a non-limiting example, business customers are further provided with a 1 Gigabit Ethernet RJ45 port 1989 coupled to SoC 1991, to which switch 1987 is coupled via Category 5e cable. Switch 1987 provides connectivity for a desired number n (typically more than two) of analog telephones 1967-1 through 1967-n, suitable for the needs of the business, via external analog telephone adapters (ATAs) 1985-1 through 1985-n. The parameter “n” in FIG. 9 is not necessarily the same as the parameter “n” in other figures, but rather generally represents a desired number of units. Connection 1995 can be, for example, via SMF (single-mode optical fiber).

In addition to “broadcast” content (e.g., video programming), the systems of FIGS. 1-6, 8, and 9 can, if desired, also deliver Internet data services using the Internet protocol (IP), although other protocols and transport mechanisms of the type well known in the digital communication art may be substituted. In the systems of FIGS. 1-6, the IP packets are typically transmitted on RF channels that are different that the RF channels used for the broadcast video and audio programming, although this is not a requirement. The CPE 106 are each configured to monitor the particular assigned RF channel (such as via a port or socket ID/address, or other such mechanism) for IP packets intended for the subscriber premises/address that they serve.

Principles of the present disclosure will be described herein in the context of apparatus, systems, and methods for insertion of modulated tones into a communications plant for leakage detection purposes, making radiation level measurements, and detecting RF leakage from the communications plant. It is to be appreciated, however, that the specific apparatus and/or methods illustratively shown and described herein are to be considered exemplary as opposed to limiting. Moreover, it will become apparent to those skilled in the art given the teachings herein that numerous modifications can be made to the embodiments shown that are within the scope of the appended claims. That is, no limitations with respect to the embodiments shown and described herein are intended or should be inferred.

Nodes are points in a network where the HFC network converts from an optical based signal transmission system to a radio-frequency (RF) based transmission system confined within a coaxial cable or other communications conduit. The nodes are typically located inside MSO facilities that house the equipment. According to some embodiments, leakage detection sites are moved beyond these sites, improving detection capabilities. In a Distributed Access Architecture (DAA), the nodes of the network become more commonly deployed toward end users (e.g., groups of homes and businesses), away from the MSO facilities. According to some embodiments of the present invention, receivers positioned within these nodes enable the reception of leakage signals, or tones, output by equipment such as cable modems disposed at end user premises. According to one or more embodiments of the present invention, triangulation of RF leakage is possible based on propagation models, with knowledge of the nodes' geographical positions, which are typically spaced thousands of feet apart.

According to some embodiments, nodes are embodied as mini-CMTS devices, serving hundreds of customers, wireless 5G CBRS (Citizens Broadband Radio Service) devices, MDUs (Multiple Dwelling Units), etc. According to one or more embodiments, the nodes are typically strung in the HFC network.

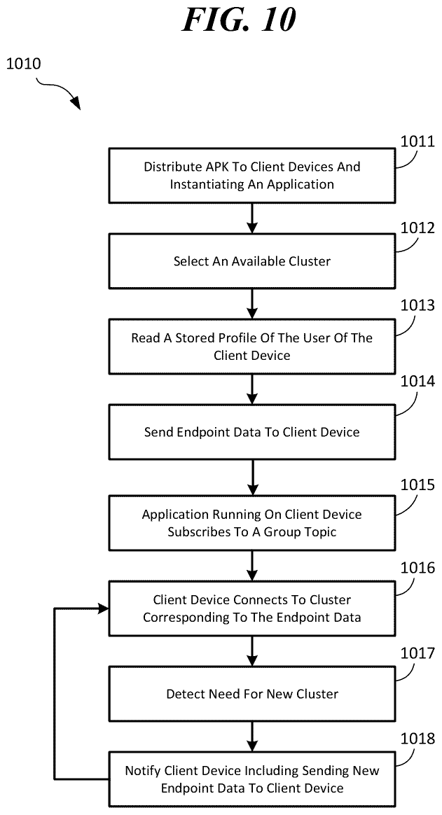

According to some embodiments and referring to FIG. 10, a method 1010 for dynamic routing of a service currently serving (i.e., performing a task for) client devices from a first cluster of one or more computer servers to a second cluster, wherein the dynamic routing is performed without the client devices downloading an application package kit specific to the second cluster, includes distributing a neutral application packet kit (APK) (at step 1011) to the client devices of technicians. According to at least one embodiment, an application of the APK is instantiated on the client devices (at step 1011) so that the application may be run of the client devices. According to some aspects, the neutral APK (at step 1011) is not configured to function in connection with a specific cluster, and instead can be connected to any of a plurality of clusters. According to one or more embodiments, when a technician logs into a mobile application running on a client device, the mobile application may choose any of the available clusters (at step 1012) as an initial cluster. The method of choosing an available cluster (at step 1012) can be performed by, for example, a random selection of an available cluster, by accessing a profile service that provides a default among the available clusters, via global server load balancing (GSLB), etc. According to some embodiments, this initially selected cluster functions as an authentication cluster.

According to some embodiments, once the mobile application running on the client device establishes a communications link with the authentication cluster, the mobile application makes a request of a profile service running on the authentication cluster for information stored in a profile that includes an assigned cluster (at step 1013) of the technician or a technician group to which the technician belongs. According to some embodiments, the profile service is highly available, with multiple instances running on multiple (or all) clusters, such that a correct profile can be provided to the mobile application establishing a communications link to any cluster. According to some aspects, the profile service is associated with a database that may be replicated and that stores the profiles of the technicians.

According to some aspects, profile data including, for example, endpoint data, is sent to the mobile application running on the client device (at step 1014) in response to the request. According to some embodiments, the mobile application, having received the profile data, subscribes to a group topic (e.g., in a cloud messaging service) given in the profile data (at step 1015).

According to some embodiments, technicians can be assigned to different groups, which are associated with group topics. For example, technician supervisors can be assigned to a group associated with a group topic “group_tech_supervisors”. According to another example, technicians can be grouped based on geographical regions, for example, associated with group topics such as city_A, county_B, service_area_C, etc. According to at least one aspect, the technicians can subscribe to one or more group topics.

According to some embodiments, notifications can be broadcast (e.g., pushed via a messaging service) to devices of technicians in a particular group topic, e.g., service_area_C. According to at least one embodiment and at step 1015, when a technician logs in, the profile of the technician includes data listing the group topic(s) that the technician belongs to, and the mobile application subscribes to those group topic(s).

According to at least one embodiment, the endpoints given in the profile can be stored on the client device (at step 1016) and used to connect to an appropriate cluster, hereinafter an initial servicing cluster. That is, the initial servicing cluster is a cluster identified in the profile information. According to at least one embodiment, the endpoint data is used to locate a resource in a network. For example, the endpoint data can be a Uniform Resource Locator (URL) of the initial servicing cluster.

According to some embodiments, upon detecting that the technician, or a group of technicians, is required to move from the initial servicing cluster to a subsequent servicing cluster (at step 1017), a notification is sent to the device of technician or the notification is broadcast to the devices of the group topic (at step 1018). For example, in a case where the endpoint needs to be changed due to a particular region being impacted (at step 1017), a notification is sent to the corresponding group topic (e.g. “city_A”). In another example where there is a need to move all technician supervisors to a different cluster, a broadcast notification is sent to topic “group_tech_Supervisor” with the new cluster endpoint data. The mobile application will receive the new cluster endpoint data, connect to the new cluster endpoints identified in the endpoint data, and from that point onwards connect to the new cluster.

According to some aspects, the notification or broadcast notification contains data identifying the endpoints of the subsequent servicing cluster (at step 1016) that the technician or group of technicians is to move to. This data identifying the endpoints of the subsequent servicing cluster is stored by the mobile application running on the client device, and the mobile application logs into the subsequent servicing cluster.

According to at least one embodiment, in the case that a circumstance requires moving the technician to a subsequent servicing cluster, a mobile command center can notify the mobile application and the technician can log-off a current cluster (i.e., the initial servicing cluster or a previous subsequent servicing cluster if the mobile application had been previously moved). According to one or more aspects, in the case that a circumstance requires moving the technician to a subsequent servicing cluster, a mobile command center can force the mobile application to log-off the current cluster automatically. In either case, on a next log-in, a new set of endpoints for the subsequent servicing cluster are communicated to the mobile application (at step 1016).

According to at least one embodiment, the mobile application receives the data about the endpoints of the subsequent servicing cluster, enabling the mobile application to log into the subsequent servicing cluster, while no new version of the APK is downloaded to the client device. That is, the neutral APK enables the mobile application to connect to any cluster of a system.

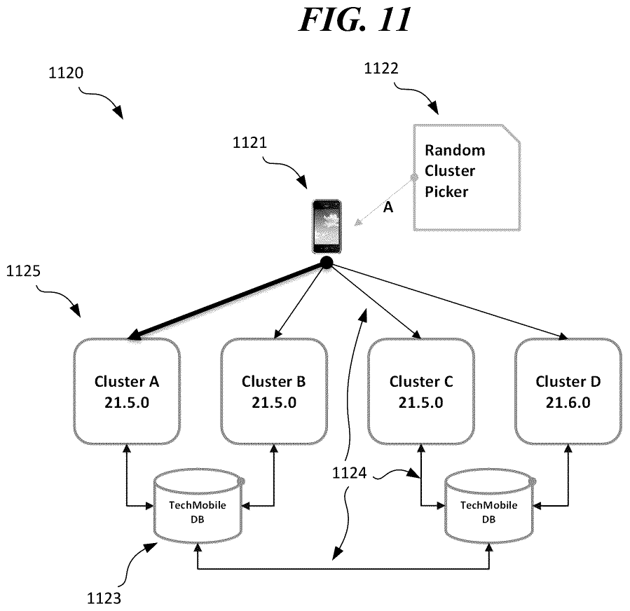

According to some aspects and referring to FIG. 11, a system 1120 includes a client device 1121 running a mobile application, a communications network 1124, and a plurality of clusters 1125, including cluster A, cluster B, cluster C, Cluster D, etc., all connected to the communications network. According to at least one embodiment, the mobile application running on the client device includes a cluster picker 1122 configured to select an authentication cluster (e.g., randomly, according to GSLB, etc.), which the mobile application may establish a communications connection with. According to some aspects, the cluster picker 1122 can be a separate application running on the client device that supports the mobile application by selecting an authentication cluster.

According to some aspects, the client device 1121 may connect to a cluster via the REST API, which conforms to the architectural constraints of REST (e.g., client-server architecture, stateless client-server communication, cacheable data, uniform interface) and allows for interaction with REST-ful web services provided by the cluster.

According to some embodiments, the system includes a plurality of mobile databases (e.g., mobile database 1123), which the clusters can connect to, store data to, read data from, etc. According to at least one embodiment, a profile database is replicated amongst all clusters, ensuring that if one of the clusters becomes unavailable, the profiles of the technicians are available on other clusters.

According to some embodiments, data provided by the clusters may be federated from multiple data centers to one database, termed a reporting database, which is hosted in any one of the mobile databases. For example, reporting data may be federated from all of the mobile database to one database. This reporting database can be hosted in any one of the mobile databases.

According to at least one embodiment, the system can support routing of one or more client devices to/from a datacenter associated with endpoint data, where the datacenter is a physical resource, typically of a discrete size. According to one embodiment, a cluster may include a datacenter or be a cluster of datacenters.

According to some aspects, the mobile databases host a backend profile service and its database. According to at least one embodiment, there are multiple mobile databases that host the profile service and database for redundancy and high availability.

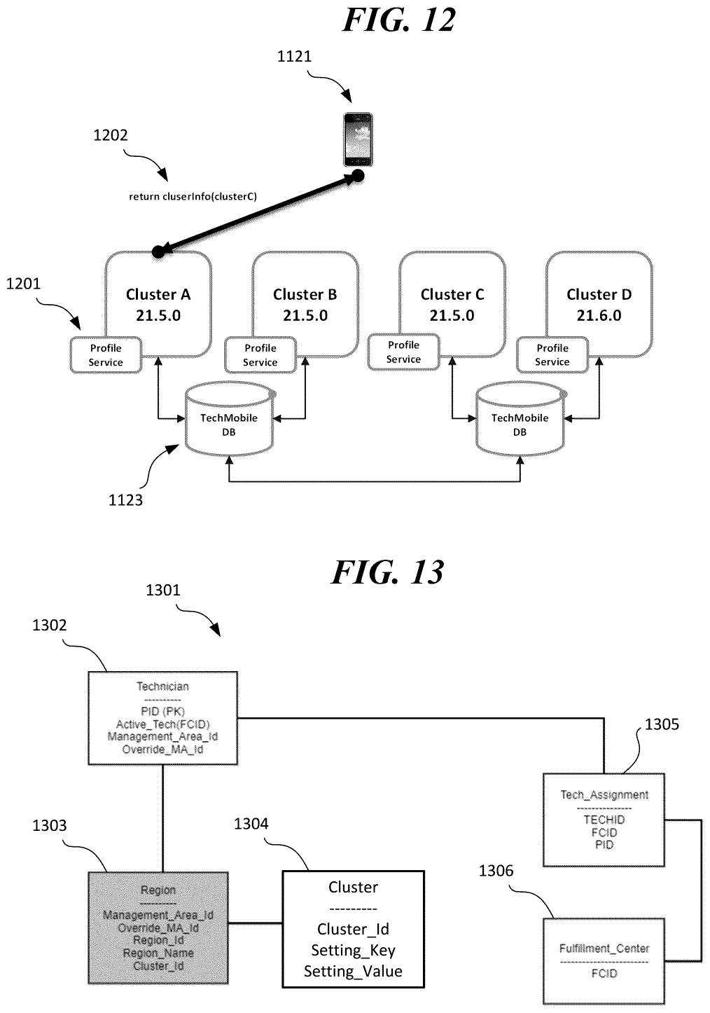

According to some aspects and referring to FIG. 12, upon establishing a connection to the authentication cluster during the log-in process, the client device 1121 issues a request (e.g., getClusterInfo(username)) for information to the authentication cluster (e.g., cluster A) and a profile service 1201 running on the authentication cluster returns the information about an initial servicing cluster that the client device is to connect to (e.g., in a command 1202 such as “return clusterinfo(clusterC)”). According to some embodiments, this information is stored in a profile of the technician saved on a mobile database (e.g., 1123) on the communications network 1124.

According to one or more embodiments, the communications network 1124 includes public network infrastructure, including for example, hybrid-fiber network, cellular infrastructure, and the like. For example, a command center may communicate with a client device through a combination of a hybrid-fiber network and a cellular network, wherein the client device is a cellular device.

According to some aspects and referring to FIG. 13, each of the mobile databases maintains system information 1301 about the system and technicians. FIG. 13 illustrates an example table structure for storing the information. According to some embodiments, the system information 1301 may include a technician profile 1302, region information 1303, cluster information 1304, technician assignments 1305, and fulfillment information 1306. It should be understood that the system information 1301 can include different data than depicted, including omitted or additional information.

According to some aspects, the region data is one example of data that may be used to classify and/or group technicians. The classification of technicians can be discrete enough to distinguish technicians based on an attribute (e.g., available tools), the region in which they work, etc.

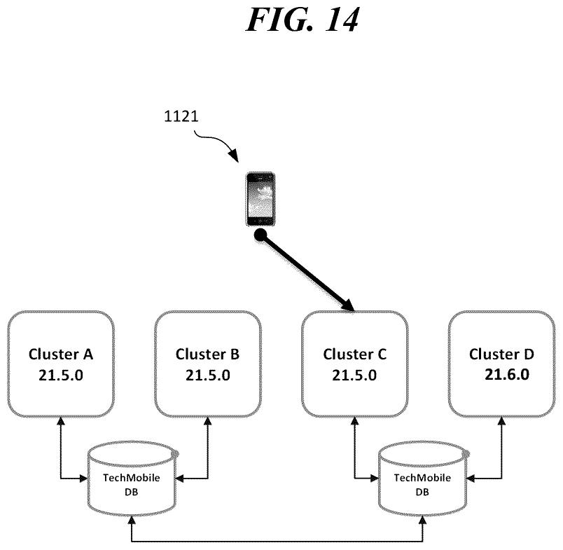

According to some aspects and referring to FIG. 14, the client device 1121, having been authenticated by an authentication service and having obtained the information about the initial servicing cluster that the client device is to connect to, completes the login with the initial servicing cluster identified in the profile, which is provided to the client device. Upon login to the initial servicing cluster, the application running on the client device may set an endpoint as part of cluster settings from the initial servicing cluster. According to some embodiments, these cluster settings can include a cluster identification (Cluster_Id), a setting key (e.g., for securing data), etc., stored as key-value pairs in a key-value pair array. According to some aspects, the cluster settings can have multiple other settings. According to some embodiments, these settings can be other configuration parameters related to the cluster or technician. According to some embodiments, the key-value pair array may be updated to include new settings, delete settings, etc. According to some embodiments, the application running on the client device can use key-value pairs to, for example, communicate with the initial servicing cluster, for example to receive data about new assignments and to send data about assignment fulfillment.

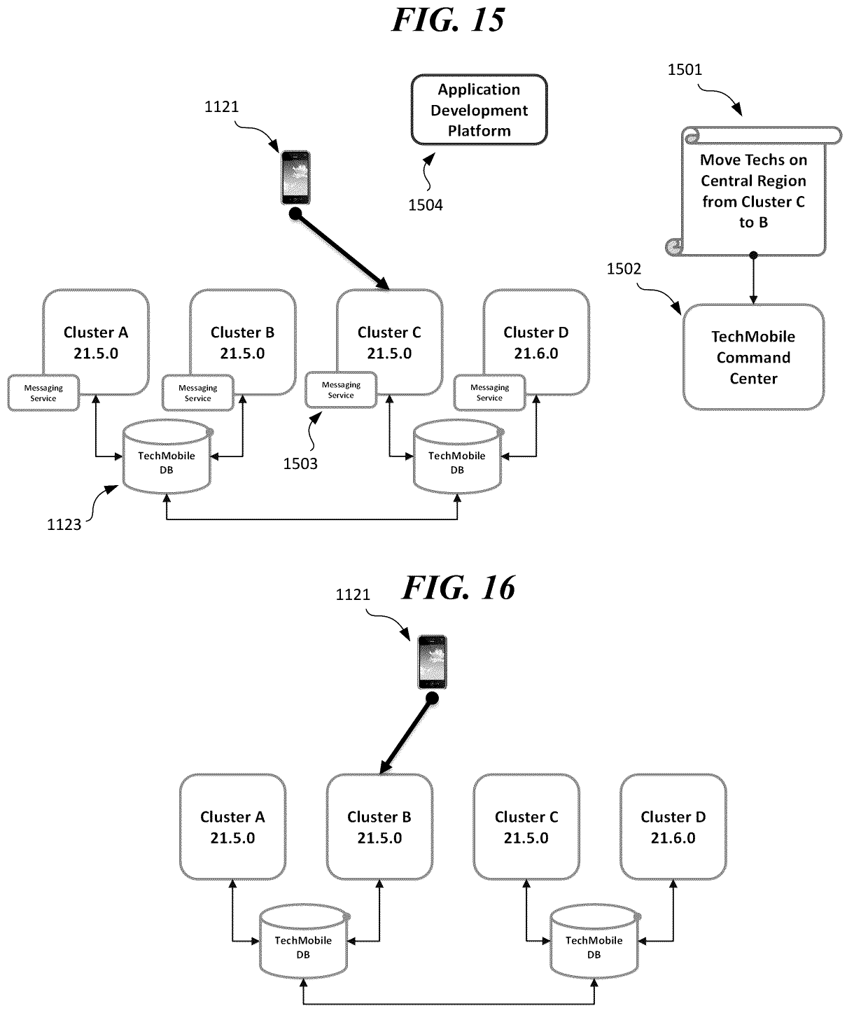

According to some aspects and referring to FIG. 15, an instruction 1501 to move a technician or a group can be generated manually or automatically; for example, upon determining that a current cluster requires maintenance or has failed in some capacity. The instruction 1501 is processed at a mobile command center 1502. According to at least one embodiment, the mobile command center 1502 updates the mobile database data stored in the mobile database(s) (e.g., mobile database 1123) (for example, using a command such as “updateTechRegion(central,clusterB)). According to at least one embodiment, the mobile command center 1502 generates a notification, such as “broadcast(topic=central,message=MOVE_TECH”, which is communicated to the technician (e.g., by a cellular signal to the client device) or broadcast to a group topic. According to at least one embodiment, the communication of the notification uses a messaging service 1503 running in the cluster(s). According to some aspects, the message service 1503 may use an application development platform 1504 to complete the communication of the notification to the application running on the client device 1121.

According to some aspects and referring to FIG. 16, the notification or broadcast notification contains data identifying the endpoints of the subsequent servicing cluster (i.e., cluster B) that the technician or group of technicians is to move to. This data identifying the endpoints of the subsequent servicing cluster is stored by the application running on the client device 1121, and the application follows the above cycle to log into the subsequent servicing cluster.

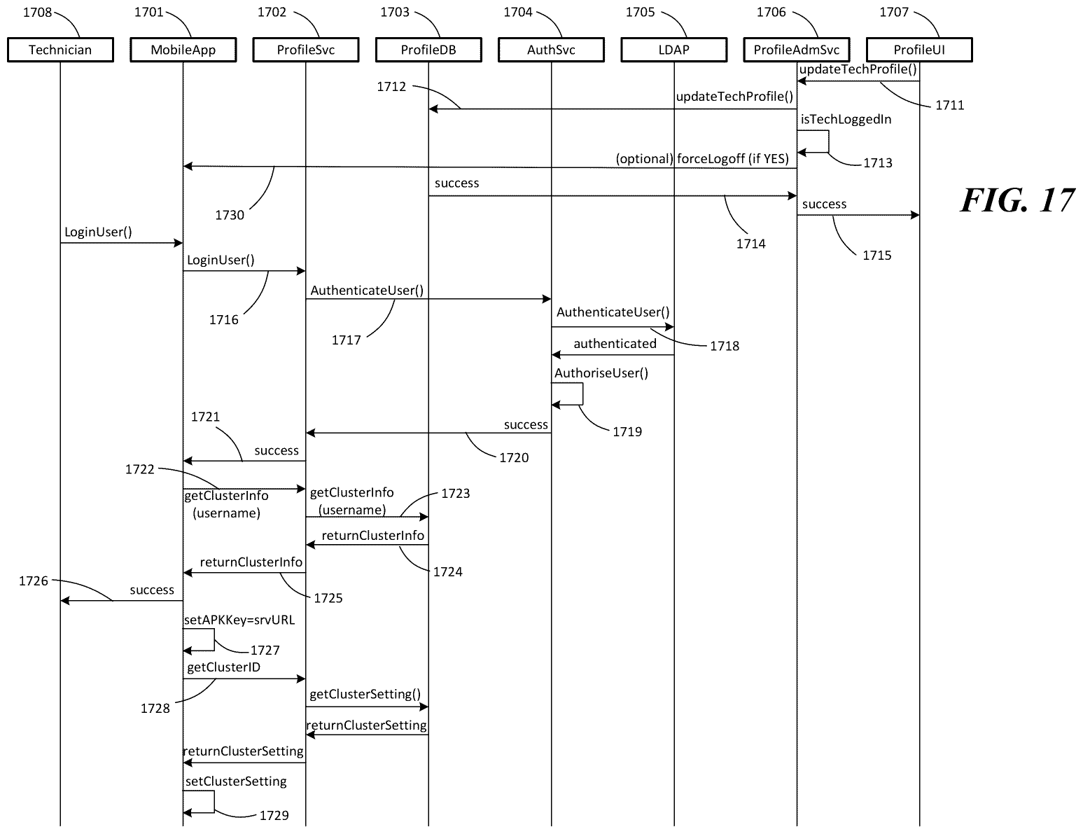

According to some aspects and referring to FIG. 17, a method of logging a technician into a cluster may use a single neutral APK. The method may be supported by one or more modules, including for example, a mobile application 1701, a profile service 1702, a profile database 1703, an authentication service 1704, a Lightweight Directory Access Protocol (LDAP) 1705, a profile administration service 1706, and a profile administration UI 1707. According to some embodiments, the method includes receiving (at step 1711), by the profile administration service 1706, an updated technician profile, and storing the updated technician profile in the profile database 1703 (at step 1712). The profile administration service 1706 can determine whether the technician(s) associated with the updated technician profile is currently logged in to a cluster (at step 1713), and if so, force the application to log off the current cluster (at step 1730), for example, by a push notification (e.g., forceLogoff(clusterInfo)). According to at least one aspect, the method may include waiting for the application to logoff from the cluster in the future. The profile database 1703 notifies the profile administration service 1706 of the success/failure of the update (at step 1714), and the success/failure is displayed by the profile administration UI 1707 (at step 1715).

According to some embodiments, on a next logging of a technician 1708, the mobile application 1701 provides identifying data (e.g., a user name and password) to the profile service 1702 (at step 1716), which can be passed to the authentication service 1704 (at step 1717) to authentic the technician (at step 1718) and authorize the technician (at step 1719). According to some embodiments, the authentication service 1704 communicates the success/failure of the authorization to the profile service 1702 (at step 1720) and the mobile application 1701 (at step 1721).

According to some aspects, the profile service 1702 is available on all clusters so that the mobile application 1701 can connect to any cluster for purposes of authentication.

According to some embodiments, the mobile application 1701 requests profile data from the profile service 1702 (at step 1722), which may access the profile database 1703 (at step 1723) to retrieve the requested information. The profile database 1703 returns the profile data to the profile service 1702 (at step 1724) and the mobile application 1701 (at step 1725) and communicates a successful login to the authentication cluster to the technician (at step 1726). According to some embodiments, the mobile application 1701 uses the profile data to set an APK key equal to the URL contained in the profile data (at step 1727). According to some aspects, the mobile application 1701 requests cluster settings (e.g., see FIG. 13) for a cluster corresponding to the URL (at step 1728) (the cluster settings may be obtained from the profile service 1702 and the profile database 1703) and the mobile application 1701 updates the appropriate settings (at step 1729), completing a login to the cluster.

Recapitulation:

According to some embodiments, a method includes: receiving, by a device connected to a communications network, a neutral application packet kit (at step 1011); running, by the device, an instance of an application corresponding to the neutral application packet kit (at step 1011); requesting, by the application, endpoint data from an authentication cluster on the communications network (at step 1013); receiving, by the application, the endpoint data from the authentication cluster (at step 1014); and connecting, by the application, to an initial servicing cluster identified by the endpoint data (at step 1016).

In some aspects, the techniques described herein relate to a method, further including: providing, by the application, identifying data to the authentication cluster; and receiving, by the application, an indication of authentication from the authentication cluster.

In some aspects, the techniques described herein relate to a method, wherein the endpoint data includes a Uniform Resource Locator (URL) of the initial servicing cluster and the method further includes configuring the application to connect to the initial servicing cluster via the communications network using the URL.

In some aspects, the techniques described herein relate to a method, further including: requesting, by the application, cluster settings of the initial servicing cluster from the initial servicing cluster; and receiving, by the application, the cluster settings.

In some aspects, the techniques described herein relate to a method, further including communication, by the application, with a profile service and causing the profile service to retrieve a profile of a technician associated with the device, wherein the profile includes the endpoint data.

In some aspects, the techniques described herein relate to a method, further including selecting, by the application, the authentication cluster.

In some aspects, the techniques described herein relate to a method, wherein the selection of the authentication cluster is a random selection performed by the application.

In some aspects, the techniques described herein relate to a method, wherein the selection of the authentication cluster is performed by a cluster picker application running on the device.

In another aspect, a method performed by an application running on a device, wherein the application corresponds to a neutral application packet kit, includes: communicating with a first instance of a service running on an initial servicing cluster (at step 1016); receiving a notification including endpoint data of a subsequent servicing cluster (at step 1018); logging off of the initial servicing cluster (at step 1730); and logging onto the subsequent servicing cluster using the endpoint data (at step 1016), wherein a second instance of the service is running on the subsequent servicing cluster.

In some aspects, the techniques described herein relate to a method, further including receiving federated data from the first instance of the service and the second instance of the service.

In some aspects, the techniques described herein relate to a method, further including receiving a command from an administration service forcing the application to log off of the initial servicing cluster.

In some aspects, the techniques described herein relate to a non-transitory computer readable medium including computer executable instructions which when executed by a computer cause the computer to perform a method of routing the computer among a plurality of computer clusters providing a service, the method including: communicating with a first instance of the service running on an initial servicing cluster of the plurality of clusters; receiving a notification including endpoint data of a subsequent servicing cluster of the plurality of clusters; logging off of the initial servicing cluster; and logging onto the subsequent servicing cluster using the endpoint data, wherein a second instance of the service is running on the subsequent servicing cluster.

In some aspects, the techniques described herein relate to a method, further including receiving federated data from the first instance of the service and the second instance of the service.

In some aspects, the techniques described herein relate to a method, further including receiving a command from an administration service forcing the computer to log off of the initial servicing cluster.

In still another aspect, a method includes: determining a condition requiring routing of a client device running an application and communicating with a first instance of a service running on a first cluster (at step 1017); updating a profile associated with a technician (at step 1711) logged into the first cluster via the client device, wherein the profile is stored on a plurality of mobile databases supporting a plurality of clusters, including the first cluster; and forcing a log off of the application from the first cluster (at step 1713).

In some aspects, the techniques described herein relate to a method, further including notifying, upon the technician initiating a login to an authentication cluster, the application running on the client device of endpoint data of a second cluster running a second instance of the service.

In some aspects, the techniques described herein relate to a method, wherein forcing the log off of the application from the first cluster includes generating a notification to the client device.

According to some embodiments, an apparatus comprises: a communications network (1124); a plurality of computer clusters (1125), wherein each computer cluster of the plurality of clusters includes an instance of a profile service (1201) storing, locally, a replicated profile of a user, and wherein each computer cluster of the plurality of clusters includes a messaging service (1503); at least one database (e.g., mobile database 1123) connected to each of the clusters by the communications network, wherein data stored in the at least one database is shared by the plurality of computer clusters; and a user device (1121) running an application (e.g., application development platform 1504) connected to a service of a first cluster of the plurality of clusters that uses the data stored in the at least one database, wherein the messaging service is configured to provide a notification to the application running on the user device enabling a login to a second cluster of the plurality of clusters providing the service.

In some aspects, the techniques described herein relate to an apparatus, further including a command center configured to generate the notification and communicate the notification to the user device using the messaging service.

In some aspects, the techniques described herein relate to an apparatus, wherein the application is configurable to connect to any cluster of the plurality of clusters, given respective endpoint data of the plurality of clusters.

According to some aspects, methods described herein may be performed by a non-transitory computer readable medium comprising computer executable instructions, which when executed by a computer cause the computer to perform a method, e.g., for routing the computer among a plurality of computer clusters providing a service.

System and Article of Manufacture Details

The invention can employ hardware aspects or a combination of hardware and software aspects. Software includes but is not limited to firmware, resident software, microcode, etc. One or more embodiments of the invention or elements thereof can be implemented in the form of an article of manufacture including a machine-readable medium that contains one or more programs which when executed implement such step(s); that is to say, a computer program product including a tangible computer readable recordable storage medium (or multiple such media) with computer usable program code configured to implement the method steps indicated, when run on one or more processors. Furthermore, one or more embodiments of the invention or elements thereof can be implemented in the form of an apparatus including a memory and at least one processor that is coupled to the memory and operative to perform, or facilitate performance of, exemplary method steps.

Yet further, in another aspect, one or more embodiments of the invention or elements thereof can be implemented in the form of means for carrying out one or more of the method steps described herein; the means can include (i) specialized hardware module(s), (ii) software module(s) executing on one or more general purpose or specialized hardware processors, or (iii) a combination of (i) and (ii); any of (i)-(iii) implement the specific techniques set forth herein, and the software modules are stored in a tangible computer-readable recordable storage medium (or multiple such media). Appropriate interconnections via bus, network, and the like can also be included.

As is known in the art, part or all of one or more aspects of the methods and apparatus discussed herein may be distributed as an article of manufacture that itself includes a tangible computer readable recordable storage medium having computer readable code means embodied thereon. The computer readable program code means is operable, in conjunction with a computer system, to carry out all or some of the steps to perform the methods or create the apparatuses discussed herein. A computer readable medium may, in general, be a recordable medium (e.g., floppy disks, hard drives, compact disks, EEPROMs, or memory cards) or may be a transmission medium (e.g., a network including fiber-optics, the world-wide web, cables, or a wireless channel using time-division multiple access, code-division multiple access, or other radio-frequency channel). Any medium known or developed that can store information suitable for use with a computer system may be used. The computer-readable code means is any mechanism for allowing a computer to read instructions and data, such as magnetic variations on a magnetic media or height variations on the surface of a compact disk. The medium can be distributed on multiple physical devices (or over multiple networks). As used herein, a tangible computer-readable recordable storage medium is defined to encompass a recordable medium, examples of which are set forth above, but is defined not to encompass transmission media per se or disembodied signals per se. Appropriate interconnections via bus, network, and the like can also be included.

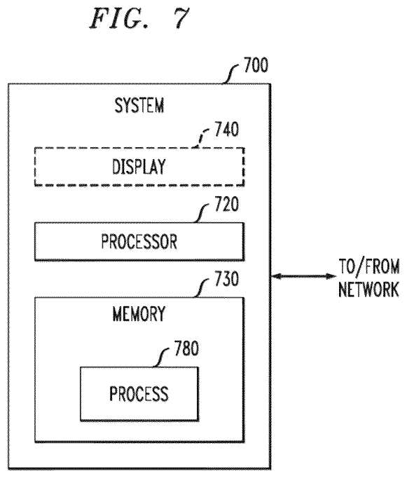

FIG. 7 is a block diagram of at least a portion of an exemplary system 700 that can be configured to implement at least some aspects of the invention, and is representative, for example, of one or more of the apparatus or modules shown in the figures. As shown in FIG. 7, memory 730 configures the processor 720 to implement one or more methods, steps, and functions (collectively, shown as process 780 in FIG. 7). The memory 730 could be distributed or local and the processor 720 could be distributed or singular. Different steps could be carried out by different processors, either concurrently (i.e., in parallel) or sequentially (i.e., in series).

The memory 730 could be implemented as an electrical, magnetic or optical memory, or any combination of these or other types of storage devices. It should be noted that if distributed processors are employed, each distributed processor that makes up processor 720 generally contains its own addressable memory space. It should also be noted that some or all of computer system 700 can be incorporated into an application-specific or general-use integrated circuit. For example, one or more method steps could be implemented in hardware in an ASIC rather than using firmware. Display 740 is representative of a variety of possible input/output devices (e.g., keyboards, mice, and the like). Every processor may not have a display, keyboard, mouse or the like associated with it.

The computer systems and servers and other pertinent elements described herein each typically contain a memory that will configure associated processors to implement the methods, steps, and functions disclosed herein. The memories could be distributed or local and the processors could be distributed or singular. The memories could be implemented as an electrical, magnetic or optical memory, or any combination of these or other types of storage devices. Moreover, the term “memory” should be construed broadly enough to encompass any information able to be read from or written to an address in the addressable space accessed by an associated processor. With this definition, information on a network is still within a memory because the associated processor can retrieve the information from the network.

Accordingly, it will be appreciated that one or more embodiments of the present invention can include a computer program comprising computer program code means adapted to perform one or all of the steps of any methods or claims set forth herein when such program is run, and that such program may be embodied on a tangible computer readable recordable storage medium. As used herein, including the claims, unless it is unambiguously apparent from the context that only server software is being referred to, a “server” includes a physical data processing system running a server program. It will be understood that such a physical server may or may not include a display, keyboard, or other input/output components. Furthermore, as used herein, including the claims, a “router” includes a networking device with both software and hardware tailored to the tasks of routing and forwarding information. Note that servers and routers can be virtualized instead of being physical devices (although there is still underlying hardware in the case of virtualization).

Furthermore, it should be noted that any of the methods described herein can include an additional step of providing a system comprising distinct software modules or components embodied on one or more tangible computer readable storage media. All the modules (or any subset thereof) can be on the same medium, or each can be on a different medium, for example. The modules can include any or all of the components shown in the figures. The method steps can then be carried out using the distinct software modules of the system, as described above, executing on one or more hardware processors. Further, a computer program product can include a tangible computer-readable recordable storage medium with code adapted to be executed to carry out one or more method steps described herein, including the provision of the system with the distinct software modules.

Accordingly, it will be appreciated that one or more embodiments of the invention can include a computer program including computer program code means adapted to perform one or all of the steps of any methods or claims set forth herein when such program is implemented on a processor, and that such program may be embodied on a tangible computer readable recordable storage medium. Further, one or more embodiments of the present invention can include a processor including code adapted to cause the processor to carry out one or more steps of methods or claims set forth herein, together with one or more apparatus elements or features as depicted and described herein.

Although illustrative embodiments of the present invention have been described herein with reference to the accompanying drawings, it is to be understood that the invention is not limited to those precise embodiments, and that various other changes and modifications may be made by one skilled in the art without departing from the scope or spirit of the invention.

What is claimed is:

1. A method comprising:
receiving, by a device connected to a communications network, a neutral application packet kit;
running, by the device, an instance of an application corresponding to the neutral application packet kit;
requesting, by the application, endpoint data from an authentication cluster on the communications network;
receiving, by the application, the endpoint data from the authentication cluster; and
connecting, by the application, to an initial servicing cluster identified by the endpoint data.

2. The method of claim 1, further comprising:
providing, by the application, identifying data to the authentication cluster; and
receiving, by the application, an indication of authentication from the authentication cluster.

3. The method of claim 1, wherein the endpoint data comprises a Uniform Resource Locator (URL) of the initial servicing cluster and the method further comprises configuring the application to connect to the initial servicing cluster via the communications network using the URL.

4. The method of claim 1, further comprising:
requesting, by the application, cluster settings of the initial servicing cluster from the initial servicing cluster; and
receiving, by the application, the cluster settings.

5. The method of claim 1, further comprising communication, by the application, with a profile service and causing the profile service to retrieve a profile of a technician associated with the device, wherein the profile includes the endpoint data.

6. The method of claim 1, further comprising selecting, by the application, the authentication cluster.

7. The method of claim 6, wherein the selection of the authentication cluster is a random selection performed by the application.

8. The method of claim 6, wherein the selection of the authentication cluster is performed by a cluster picker application running on the device.

9. A method performed by an application running on a device, wherein the application corresponds to a neutral application packet kit, the method comprising:
communicating with a first instance of a service running on an initial servicing cluster;
receiving a notification including endpoint data of a subsequent servicing cluster;
logging off of the initial servicing cluster; and
logging onto the subsequent servicing cluster using the endpoint data, wherein a second instance of the service is running on the subsequent servicing cluster.

10. The method of claim 9, further comprising receiving federated data from the first instance of the service and the second instance of the service.

11. The method of claim 9, further comprising receiving a command from an administration service forcing the application to log off of the initial servicing cluster.

12. A non-transitory computer readable medium comprising computer executable instructions which when executed by a computer cause the computer to perform a method of routing the computer among a plurality of computer clusters providing a service, the method comprising:
communicating with a first instance of the service running on an initial servicing cluster of the plurality of clusters;
receiving a notification including endpoint data of a subsequent servicing cluster of the plurality of clusters;
logging off of the initial servicing cluster; and
logging onto the subsequent servicing cluster using the endpoint data, wherein a second instance of the service is running on the subsequent servicing cluster.

13. The method of claim 12, further comprising receiving federated data from the first instance of the service and the second instance of the service.

14. The method of claim 12, further comprising receiving a command from an administration service forcing the computer to log off of the initial servicing cluster.

15. A method comprising:
determining a condition requiring routing of a client device running an application and communicating with a first instance of a service running on a first cluster;
updating a profile associated with a technician logged into the first cluster via the client device, wherein the profile is stored on a plurality of mobile databases supporting a plurality of clusters, including the first cluster; and
forcing a log off of the application from the first cluster.

16. The method of claim 15, further comprising notifying, upon the technician initiating a login to an authentication cluster, the application running on the client device of endpoint data of a second cluster running a second instance of the service.

17. The method of claim 15, wherein forcing the log off of the application from the first cluster comprises generating a notification to the client device.

18. An apparatus comprising:
a communications network;
a plurality of computer clusters, wherein each computer cluster of the plurality of clusters includes an instance of a profile service storing, locally, a replicated profile of a user, and wherein each computer cluster of the plurality of clusters includes a messaging service;
at least one database connected to each of the clusters by the communications network, wherein data stored in the at least one database is shared by the plurality of computer clusters; and
a user device running an application connected to a service of a first cluster of the plurality of clusters that uses the data stored in the at least one database,
wherein the messaging service is configured to provide a notification to the application running on the user device enabling a login to a second cluster of the plurality of clusters providing the service.

19. The apparatus of claim 18, further comprising a command center configured to generate the notification and communicate the notification to the user device using the messaging service.

20. The apparatus of claim 18, wherein the application is configurable to connect to any cluster of the plurality of clusters, given respective endpoint data of the plurality of clusters.
